(19) United States
(12) Patent Application Publication
(10) Pub. No.: US 2024/0135439 A1
(43) Pub. Date: Apr. 25, 2024

(54) SYSTEMS AND METHODS FOR RAPID BID EVALUATION AND ANALYSIS

(71) Applicant: Paul B. Evans, Woodbridge, CT (US)

(72) Inventor: Paul B. Evans, Woodbridge, CT (US)

(21) Appl. No.: 18/348,054

(22) Filed: Jul. 6, 2023

Related U.S. Application Data
(60) Provisional application No. 63/367,869, filed on Jul. 7, 2022.

(51) Int. Cl. G06Q 30/08; G06Q 50/163

(52) U.S. Cl. CPC G06Q 30/08; G06Q 50/163

(57) ABSTRACT

A system and method are herein disclosed. The system comprises a processor; a communication device; and a non-transitory computer-readable medium. The non-transitory computer-readable medium stores processor-executable instructions that when executed by the processor, cause the processor to: receive a plurality of property criteria for a subject property; receive a plurality of comparables criteria; calculate one or more suggested bid amount based at least in part on the plurality of property criteria, the plurality of comparables criteria, and a success threshold provided by the user; and transmit an interactive interface to a user device, the interactive interface displaying the one or more suggested bid amount and operable to transmit a user feedback.

### CROSS-REFERENCE TO RELATED APPLICATIONS

The present application claims priority to Provisional Patent Application U.S. Ser. No. 63/367,869 titled “SYSTEMS AND METHODS FOR RAPID BID EVALUATION AND ANALYSIS” filed on Jul. 7, 2023, the entire content of which is hereby expressly incorporated herein by reference.

### BACKGROUND OF THE INVENTION

Currently, properties on the market are bought and sold within days instead of weeks or months. Many times, when a house or property is listed, dozens of bids for purchase of the property are received within the first day, and many bids may be received even within the first hour.

From a purchaser's perspective, it may be difficult to determine how much to bid for the property without in-depth analysis of comparable sales in the area, which takes precious time and resources. With property prices changing at an astounding rate, it is difficult to quickly and accurately determine a bid price relative to an asking price of the property that will result in a high chance of purchasing the property without bidding more than the property is worth.

Therefore, a need exists for systems and methods to rapidly evaluate a property and comparable sales to provide a purchaser with an accurate bid for the property, it is to such systems and methods that the present disclosure is directed.

### SUMMARY OF THE INVENTION

The problem of rapidly evaluating a property and comparable sales to provide a purchaser with an accurate bid for the property without bidding more than the property is worth while also taking into account a desired rate of success is solved by the systems and methods herein disclosed. The systems and methods include a system comprising a processor; a communication device; and a non-transitory computer-readable medium. The non-transitory computer-readable medium stores processor-executable instructions that when executed by the processor, cause the processor to: receive a plurality of property criteria for a subject property; receive a plurality of comparables criteria; calculate one or more suggested bid amount based at least in part on the plurality of property criteria, the plurality of comparables criteria, and a success threshold provided by the user; and transmit an interactive interface to a user device, the interactive interface displaying the one or more suggested bid amount and operable to transmit a user feedback.

Implementations of the above techniques include methods, apparatus, systems, and computer program products. One such computer program product is suitably embodied in a non-transitory computer-readable medium that stores instructions executable by one or more processors. The instructions are configured to cause the one or more processors to perform the above-described actions.

The details of one or more implementations of the subject matter of this specification are set forth in the accompanying drawings and the description below. Other aspects, features and advantages will become apparent from the description, the drawings, and the claims.

### BRIEF DESCRIPTION OF DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a diagram of an exemplary embodiment of hardware forming a system constructed in accordance with the present disclosure.

FIG. 2 is a diagram of an exemplary embodiment of a user device for use in the system of FIG. 1 constructed in accordance with the present disclosure.

FIG. 3 is a diagram of an exemplary embodiment of an apparatus for use in the system of FIG. 1 constructed in accordance with the present disclosure.

FIG. 4 is a process flow diagram of an exemplary embodiment of a process in accordance with the present disclosure.

FIGS. 5A-D are diagrams of exemplary embodiments of an interactive interface constructed in accordance with the present disclosure.

FIG. 6 is a diagram of an exemplary embodiment of an interactive interface constructed in accordance with the present disclosure.

### DETAILED DESCRIPTION

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted. The disclosure is capable of other embodiments or of being practiced or carried out in various ways. Also, it is to be understood that the phraseology and terminology employed herein is for purposes of description and should not be regarded as limiting.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements but may also include other elements not expressly listed or inherent to such process, method, article, or apparatus.

Further, unless expressly stated to the contrary, “or” refers to an inclusive and not to an exclusive “or”. For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to computing tolerances, computing error, manufacturing tolerances, measurement error, wear and tear, stresses exerted on various parts, and combinations thereof, for example.

As used herein, any reference to “one embodiment,” “an embodiment,” “some embodiments,” “one example,” “for example,” or “an example” means that a particular element, feature, structure or characteristic described in connection with the embodiment is included in at least one embodiment and may be used in conjunction with other embodiments. The appearance of the phrase “in some embodiments” or “one example” in various places in the specification is not necessarily all referring to the same embodiment, for example.

The use of ordinal number terminology (i.e., “first”, “second”, “third”, “fourth”, etc.) is solely for the purpose of differentiating between two or more items and, unless explicitly stated otherwise, is not meant to imply any sequence or order of importance to one item over another.

The use of the term “at least one” or “one or more” will be understood to include one as well as any quantity more than one. In addition, the use of the phrase “at least one of X, Y, and Z” will be understood to include X alone, Y alone, and Z alone, as well as any combination of X, Y, and Z.

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the invention as described herein. Where a range of numerical values is stated herein as being less than a stated value, the range is nevertheless bounded on its lower end by a non-zero value. It is not intended that the scope of the invention be limited to the specific values recited when defining a range. All ranges are inclusive and combinable.

Circuitry, as used herein, may be analog and/or digital components, or one or more suitably programmed processors (e.g., microprocessors) and associated hardware and software, or hardwired logic. Also, “components” may perform one or more functions. The term “component,” may include hardware, such as a processor (e.g., microprocessor), an application specific integrated circuit (ASIC), a field programmable gate array (FPGA), a combination of hardware and software, software, and/or the like. The term “processor” as used herein means a single processor or multiple processors working independently or together to collectively perform a task.

Software may include one or more computer readable instruction that when executed by one or more component, e.g., a processor, causes the component to perform a specified function. It should be understood that the algorithms described herein may be stored on one or more non-transitory computer-readable medium. Exemplary non-transitory computer-readable mediums may include a non-volatile memory, a random access memory (RAM), a read only memory (ROM), a CD-ROM, a hard drive, a solid-state drive, a flash drive, a memory card, a DVD-ROM, a BluRay Disk, a laser disk, a magnetic disk, an optical drive, combinations thereof, and/or the like.

Such non-transitory computer-readable mediums may be electrically based, optically based, magnetically based, resistive based, and/or the like. Further, the messages described herein may be generated by the components and result in various physical transformations.

As used herein, the terms “network-based,” “cloud-based,” and any variations thereof, are intended to include the provision of configurable computational resources on demand via interfacing with a computer and/or computer network, with software and/or data at least partially located on a computer and/or computer network.

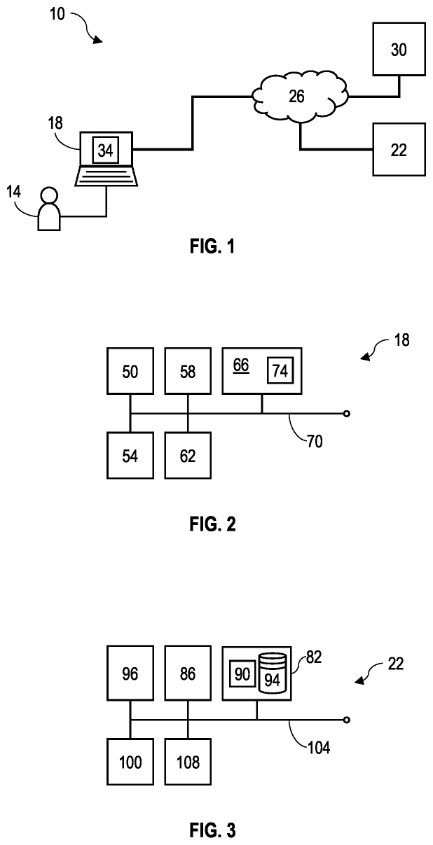

Referring now to the drawings, and in particular to FIG. 1, shown therein is a diagram of an exemplary embodiment of a system 10 constructed in accordance with the present disclosure. A user 14 may interact with the system 10 using a user device 18 that may be used to request bidding thresholds from an apparatus 22. The user device 18 may communicate with the apparatus 22 via a network 26. The apparatus 22 may communicate with one or more third-party system 30 via the network 26.

In some embodiments, the network 26 may be the Internet and/or other network. For example, if the network 26 is the Internet, an application 34 (described below in more detail) of the system 10 may be delivered through a series of web pages or private internal web pages of a company or corporation, which may be written in hypertext markup language, for example, and may be accessible by the user device 18. It should be noted that the primary user interface of the system 10 may be another type of interface including, but not limited to, a Windows-based application, a tablet-based application, a mobile web interface, an application running on a mobile device, a virtual-reality interface, an augmented-reality interface, and/or the like.

The network 26 may be almost any type of network. For example, in some embodiments, the network 26 may be a version of an Internet network (e.g., exist in a TCP/IP-based network). In one embodiment, the network 26 is the Internet. It should be noted, however, that the network 26 may be almost any type of network and may be implemented as the World Wide Web (or Internet), a local area network (LAN), a wide area network (WAN), an LPWAN, a LoRaWAN, a metropolitan network, a wireless network, a cellular network, a Bluetooth network, a Global System for Mobile Communications (GSM) network, a code division multiple access (CDMA) network, a 3G network, a 4G network, an LTE network, a 5G network, a satellite network, a radio network, an optical network, a cable network, a public switched telephone network, an Ethernet network, a short-wave wireless network, a long-wave wireless network, combinations thereof, and/or the like. It is conceivable that in the near future, embodiments of the present disclosure may use more advanced networking topologies.

The number of devices and/or networks illustrated in FIG. 1 is provided for explanatory purposes. In practice, there may be additional devices and/or networks, fewer devices and/or networks, different devices and/or networks, or differently arranged devices and/or networks than are shown in FIG. 1. Furthermore, two or more of the devices illustrated in FIG. 1 may be implemented within a single device, or a single device illustrated in FIG. 1 may be implemented as multiple, distributed devices. Additionally, or alternatively, one or more of the devices of system 10 may perform one or more functions described as being performed by another one or more of the devices of the system 10. Devices of the system 10 may interconnect via wired connections, wireless connections, or a combination thereof.

Referring now to FIG. 2, shown therein is a diagram of an exemplary embodiment of the user device 18 of the system 10 constructed in accordance with the present disclosure. In some embodiments, the user device 18 may include, but is not limited to, implementations as a personal computer, a cellular telephone, a smart phone, a network-capable television set, a tablet, a laptop computer, a desktop computer, a network-capable handheld device, a server, a digital video recorder, a wearable network-capable device, a virtual reality/augmented reality device, and/or the like.

In some embodiments, the user device 18 may include one or more input device 50 (hereinafter “input device 50”), one or more output device 54 (hereinafter “output device 54”), one or more processor 58 (hereinafter “processor 58”), one or more communication device 62 (hereinafter “communication device 62”) capable of interfacing with the network 26, one or more non-transitory computer-readable memory 66 (hereinafter “memory 66”) storing processor-executable code and/or software application(s), for example including, a web browser capable of accessing a website and/or communicating information and/or data over a wireless or wired network (e.g., the network 26), and/or the like. The input device 50, output device 54, processor 58, communication device 62, and memory 66 may be connected via a path 70 such as a data bus that permits communication among the components of user device 18.

The memory 66 may store a user application 74 that, when executed by the processor 58 causes the user device 18 to perform an action such as communicate with or control one or more component of the user device 18 and/or, via the network 26, the apparatus 22.

The input device 50 may be capable of receiving information input from the user 14 and/or processor 58, and transmitting such information to other components of the user device 18 and/or the network 26. The input device 50 may include, but is not limited to, implementation as a keyboard, a touchscreen, a mouse, a trackball, a microphone, a camera, a fingerprint reader, an infrared port, an optical port, a cell phone, a smart phone, a PDA, a remote control, a fax machine, a wearable communication device, a network interface, combinations thereof, and/or the like, for example.

The output device 54 may be capable of outputting information in a form perceivable by the user 14 and/or processor 58. Implementations of the output device 54 may include, but are not limited to, a computer monitor, a screen, a touchscreen, a speaker, a website, a television set, a smart phone, a PDA, a cell phone, a fax machine, a printer, a laptop computer, a haptic feedback generator, an olfactory generator, combinations thereof, and the like, for example. It is to be understood that in some exemplary embodiments, the input device 50 and the output device 54 may be implemented as a single device, such as, for example, a touchscreen of a computer, a tablet, or a smartphone. It is to be further understood that as used herein the term user (e.g., the user 14) is not limited to a human being, and may comprise a computer, a server, a website, a processor, a network interface, a user terminal, a virtual computer, combinations thereof, and/or the like, for example.

The network 26 may permit bi-directional communication of information and/or data between the user device 18 and/or the apparatus 22. The network 26 may interface with the apparatus 22 and/or the user device 18 in a variety of ways. For example, in some embodiments, the network 26 may interface by optical and/or electronic interfaces, and/or may use a plurality of network topographies and/or protocols including, but not limited to, Ethernet, TCP/IP, circuit switched path, combinations thereof, and/or the like as described above.

Exemplary embodiments of the processor 58 may include, but are not limited to, a digital signal processor (DSP), a central processing unit (CPU), a field programmable gate array (FPGA), a microprocessor, a multi-core processor, an application specific integrated circuit (ASIC), combinations, thereof, and/or the like, for example. The processor 58 may be capable of communicating with the memory 66 via the path 70 (e.g., data bus). The processor 58 may be capable of communicating with the input device 50 and/or the output device 54.

Referring now to FIG. 3, shown therein is a diagram of an exemplary embodiment of the apparatus 22 constructed in accordance with the present disclosure. The apparatus 22 may include one or more devices that execute one or more application or service in a manner described herein. In the illustrated embodiment, the apparatus 22 is provided with non-transitory computer-readable storage memory 82 (hereinafter “memory 82”) accessible by one or more processor 86 (hereinafter “processor 86”). The memory 82 may store a software 90 and one or more database 94 (hereinafter “database 94”).

In some embodiments, the apparatus 22 may comprise one or more processor 86 working together, or independently to, execute processor-executable code, such as the software 90, stored on the memory 82. Additionally, each apparatus 22 may include at least one input device 96 (hereinafter “input device 96”) and at least one output device 100 (hereinafter “output device 100”). Each element of the apparatus 22 may be partially or completely network-based or cloud-based, and may or may not be located in a single physical location.

The processor 86 may be implemented as a single processor or multiple processors working together, or independently, to execute the software 90 as described herein. It is to be understood, that in certain embodiments using more than one processor 86, the processors 86 may be located remotely from one another, located in the same location, or comprising a unitary multi-core processor. The processors 86 may be capable of reading and/or executing processor-executable code and/or capable of creating, manipulating, retrieving, altering, and/or storing data structures into the memory 82 such as in the database 94.

Exemplary embodiments of the processor 86 may be constructed similar to and in accordance with the processor 58 described above in more detail. The processor 86 may be capable of communicating with the memory 82 via a path 104 (e.g., data bus). The processor 86 may be capable of communicating with the input device 96 and/or the output device 100.

The processor 86 may be further capable of interfacing and/or communicating with the user device 18 and/or the third-party system 30 via the network 26 using a communication device 108. For example, the processor 86 may be capable of communicating via the network 26 by exchanging signals (e.g., analog, digital, optical, and/or the like) via one or more ports (e.g., physical or virtual ports) using a network protocol to provide updated information to the application 74 executed on the user device 18.

In some embodiments, the memory 82 may be located in the same physical location as the apparatus 22, and/or one or more memory 82 may be located remotely from the apparatus 22. For example, the memory 82 may be located remotely from the apparatus 22 and communicate with the processor 86 via the network 26. Additionally, when more than one memory 82 is used, a first memory 82 may be located in the same physical location as the processor 86, and additional memory 82 may be located in a location physically remote from the processor 86. Additionally, the memory 82 may be implemented as a “cloud” non-transitory computer-readable storage memory (i.e., one or more memory 82 may be partially or completely based on or accessed using the network 26).

The memory 82 may store processor-executable code and/or information comprising the database 94 and the software 90. In some embodiments, the software 90 may be stored as a compiled application file, such as an executable file, for example, or in a structure (or unstructured) format, such as, e.g., in a non-compiled file.

The input device 96 of the apparatus 22 may transmit data to the processor 86 and may be constructed in accordance with or similar to the input device 50 of the user device 18 described above in more detail. The input device 96 may be located in the same physical location as the processor 86, or located remotely and/or partially or completely network-based. The output device 100 of the apparatus 22 may transmit information from the processor 86 to the user 12, and may be similar to the output device 54 of the user device 18. The output device 100 may be located with the processor 86, or located remotely and/or partially or completely network-based.

In one embodiment, the apparatus 22 is an analytics tool to analyze data. The data may be retrieved from one or more database or third-party system 30. In some embodiments, the apparatus 22 may receive a datastream and store the datastream into a database. In some embodiments, both live data and archival data is stored in the database.

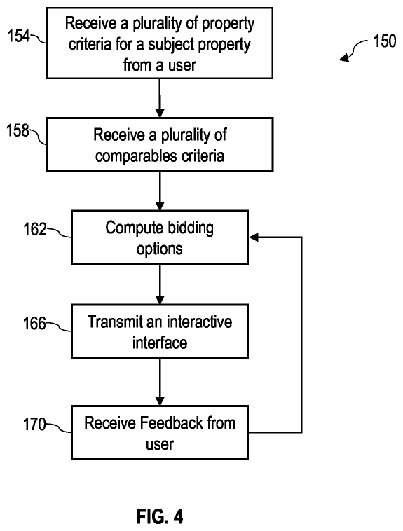

Referring now to FIG. 4, shown therein is a process flow diagram of an exemplary embodiment of a bidding assessment process 150 constructed in accordance with the present disclosure. Generally, the bidding assessment process 150 comprises the steps of: receiving a plurality of property criteria for a subject property from a user (step 154); receiving a plurality of comparables criteria (step 158); computing bidding options (step 162); transmit, to the user, an interactive interface (step 166); upon feedback from the user, return to step 162 (step 170). The bidding assessment process 150 may be stored as software, e.g., computer executable instructions, that when executed by a processor (e.g., the processor 86) causes the processor 86 to execute one or more step of the bidding assessment process 150. The software may be the software 90 stored in the memory 82 of the apparatus 22, for example.

In one embodiment, receiving a plurality of property criteria for a subject property from a user (step 154) comprises receiving from the user device 18, via the network 26, the plurality of property criteria for the subject property and storing the plurality of property criteria in the memory 82 and/or the database 94.

In one embodiment, receiving a plurality of property criteria for a subject property from a user (step 154) comprises receiving from a user, via the interactive interface of the application 34, property criteria including at least a property location and a property list price. The property criteria may also include a property size. In some embodiments, the property location is one or more of a country, a state, a county, a town, a Zip Code, a Post Office, a school district, a borough, a development, a subdivision, a neighborhood, a region, a city, a village, a hamlet, a Census Designated Place (CDP), a Metropolitan Statistical Area (MSA), an address, a district, a community, and/or the like. Generally, the subject property location may establish geographic bounds around the property and has other similarly situated properties within. The property list price is the price at which the subject property is listed for sale. The property size may be either the square feet of livable area of the subject property and/or a total area of the subject property in square feet. In some embodiments, an MLS system utilized for the subject property may determine whether the property size is a livable area or a total area, or both.

In one embodiment, receiving a plurality of property criteria for a subject property from a user (step 154) further comprises receiving property criteria including a property type, such as, whether the property is a single-family property, a condo property, a multi-family property, a co-op property, and/or the like. Generally, the property criteria includes one or more criteria of the subject property, i.e., the property for which the user desires to bid.

In one embodiment, receiving a plurality of property criteria for a subject property from a user (step 154) further comprises receiving property criteria including whether the property has a home owners association (HOA).

In one embodiment, receiving a plurality of property criteria for a subject property from a user (step 154) further comprises receiving more than one location as the property location.

In one embodiment, receiving a plurality of property criteria for a subject property from a user (step 154) further comprises receiving a property criteria of a tax value. Receiving the tax value may include receiving the tax value from the user. In other embodiments, receiving the tax value includes the apparatus 22 retrieving a tax assessment from a third-party system 30, for example, the county assessor system for the subject property, retrieving a property tax from a third-party system 30, and/or retrieving both the tax assessment and the property tax from a third-party system 30. In other words, the tax value may be one or more of the tax assessment or the property tax for the subject property. In some embodiments, an MLS system utilized for the subject property may determine whether the tax value is a property tax or a tax assessment or both.

In one embodiment, receiving a plurality of comparables criteria (step 158) comprises receiving, from the user device 18 via the network 26 the plurality of comparables criteria and storing the comparables criteria in the memory 82 and/or in the database 94, for example.

In one embodiment, receiving a plurality of comparables criteria (step 158) comprises receiving from a user, via the interactive interface of the application 34, comparables criteria including, for example, a minimum list price, a maximum list price, a minimum acres, a maximum acres, a minimum comp property size, a maximum comp property size, a minimum comp bedrooms, a maximum comp bedrooms, and/or the like.

In one embodiment, receiving a plurality of comparables criteria (step 158) comprises receiving only a minimum list price and a maximum list price.

In one embodiment, receiving a plurality of comparables criteria (step 158) comprises receiving a history duration. The history duration may include, for example, a number of months of history to user for a comparables calculation. Alternatively, the history duration may include any duration of time, for example, a number of days or a number of weeks.

In one embodiment, receiving a plurality of comparables criteria (step 158) comprises setting an initial comparables criteria at a predetermined offset from the subject property criteria where the predetermined offset is below a maximum offset threshold. In some embodiments, the predetermined offset is a percent. That is, if a subject property criterion is a list price, the initial comparables criteria may include a minimum list price and a maximum list price, each offset from the subject property list price by the predetermined percent offset, i.e., the minimum list price is set at the predetermined offset below the subject property list price and the maximum list price is set at the predetermined offset above the subject property list price.

In one embodiment, the predetermined percent offset may be any percentage between 0% and a maximum percentage threshold, and preferably is about 5% initially. The maximum percentage threshold is preferable about 30%, however, the maximum percentage threshold may be configurable by the user.

In other embodiments, the predetermined increment is a value based on the unit of the comparables criteria.

In one embodiment, the apparatus 22 may be in communication with an MLS third-party system and query the MLS third-party system with the plurality of comparables criteria such that the number of returned comparable properties meets or exceeds a predetermined comparables threshold. In one embodiment, the predetermined comparables threshold is about 15 properties, however, the predetermined comparables threshold may be configurable by the user and selected by the user. If the number of returned comparable properties does not meet the predetermined comparables threshold, the comparables criteria may be adjusted by incrementally increasing the predetermined offset until either the number of returned comparable properties meets or exceeds the predetermined comparables threshold or the predetermined offset reaches the maximum offset threshold.

In one embodiment, if the predetermined offset reaches the maximum offset threshold, the apparatus 22 may increase the history duration, reset the initial comparables criteria at the predetermined offset from the subject property criteria, and query the MLS third-party system with the plurality of comparables criteria such that the number of returned comparable properties meets or exceeds a predetermined comparables threshold. Similarly, if the number of returned comparable properties does not meet the predetermined comparables threshold, the comparables criteria may be adjusted by incrementally increasing the predetermined offset until either the number of returned comparable properties meets or exceeds the predetermined comparables threshold or the predetermined offset reaches the maximum offset threshold, at which point the apparatus 22 may increase the history duration again. The apparatus 22 may continue to increase the history duration, reset the initial comparables criteria, and query the MLS third-party system for returned comparable properties until the number of returned comparable properties meets or exceeds the predetermined comparables threshold.

In one embodiment, the apparatus 22 may continue to increase the history duration until the history duration reaches a duration threshold, such as, for example, 12 months, at which point the user may be informed that no comparable properties are within the maximum offset threshold of the subject property criteria for the previous duration threshold period of time.

In one embodiment, computing bidding options (step 162) comprises computing, by the processor 86 of the apparatus 22 the bidding options.

In one embodiment, computing bidding options (step 162) comprises retrieving one or more comparables properties from a third-party system 30, e.g., by the processor 86 via the network 26. The one or more retrieved comparables properties may meet at least one threshold based upon the comparables criteria. Additional information may be retrieved from the third-party system 30 for each retrieved comparables properties, including at least a list price, a sale price, a tax value, and a property area. In some embodiments, the additional information includes at least the subject property criteria entered in by the user, that is, if the user enters in a property size for the subject property, the apparatus 22 may retrieve from the third-party system 30 a property size for each of the retrieved comparables properties, but if the user does not enter a value for the property size for the subject property, the apparatus 22 may not retrieve from the third-party system 30 the property size for each of the retrieved comparables properties.

In one embodiment, the apparatus 22 communicates with the third-party system 30 via the network 26. The apparatus 22 may communicate with the third-party system 30 via an API, such as a RESTFUL API, and/or the like.

In one embodiment, computing bidding options (step 162) comprises determining a plurality of comparable properties that meet the thresholds provided by the comparables criteria. After determining the plurality of comparable properties, one or more frequency distribution is calculated.

In one embodiment, the apparatus 22 may be in communication with the MLS third-party system and query the MLS third-party system for the plurality of comparable properties such that the number of returned comparable properties meets or exceeds a predetermined comparables threshold as described above in more detail. In one embodiment, the predetermined comparables threshold is about 15 properties, however, the predetermined comparables threshold may be configurable by the user and selected by the user.

In one embodiment, the one or more frequency distribution includes a sales price per list price ratio frequency distribution. In one embodiment, the sales price per list price ratio frequency distribution may be calculated by computing a sales prices per list price quotient for each of the plurality of comparable properties. The quotient may then be expressed as percentages. For example, if the list price for a particular comparable property is $500,000 and the sales price for that particular property is $525,000, then the sales per list price quotient is calculated by

$$\frac{\$525 , 000}{\$500 , 000} = 1.05$$

or 105%. In some embodiments, the quotient is rounded to the nearest integer percentage point. The sales price per list price ratio frequency distribution thus includes each sales price per list price quotient for each of the plurality of comparable properties. The sales price per list price ratio frequency distribution may be used to calculate a suggested bid price as described below.

In one embodiment, a first frequency distribution may be calculated for a sale price per tax value ratio based upon the sale price and tax value for each of the plurality of comparable properties. The tax value for each of the plurality of comparable properties may be an assessment tax type and/or a property tax type; however, whichever tax type is used, that tax type should be utilized for comparison and frequency distribution calculation for all of the plurality of comparable properties.

In one embodiment, a second frequency distribution may be calculated for a sale price per property size ratio. In one embodiment, a third frequency distribution may be calculated for a sale price per acreage ratio. In other embodiments, a frequency distribution may be calculated for each comparables criteria.

In one embodiment, computing bidding options (step 162) further comprises, upon determination of each frequency distribution, determining a position within the frequency distribution of the subject property, and, based upon a success threshold, calculate a suggested bid amount and/or or a bid percent. For example, if the success threshold is 80%, that is, if the user would like an 80% chance of buying the subject property, the bid amount is calculated by determining the bid amount at the 80th percentile of at least one of the one or more frequency distribution (for example, the sale price per list price frequency distribution). The bid percent, then, may be the percent above the subject property list price that results in the determined bid amount.

In one embodiment, transmitting, to the user, an interactive interface (step 166) comprises transmitting, by the apparatus 22, to the user 14 an interactive interface to the application 34 of the user device 18, via the network 26.

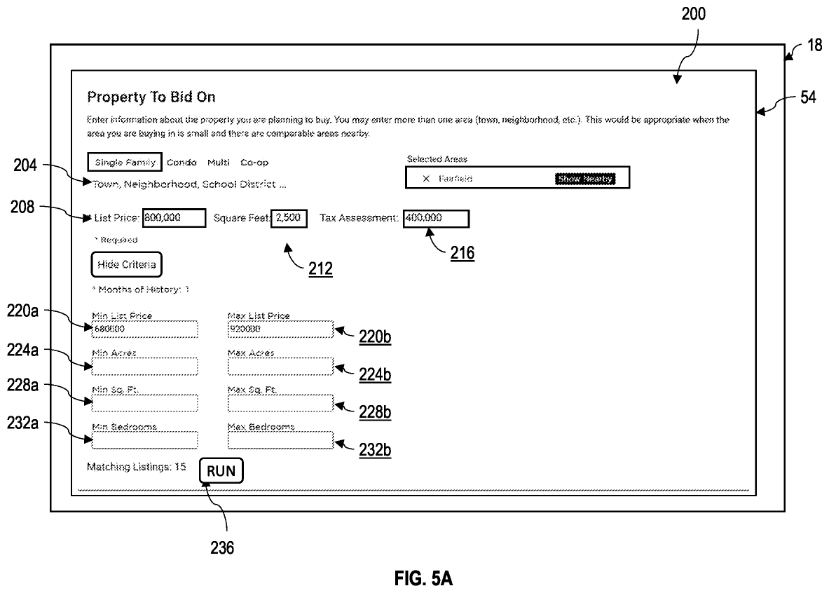

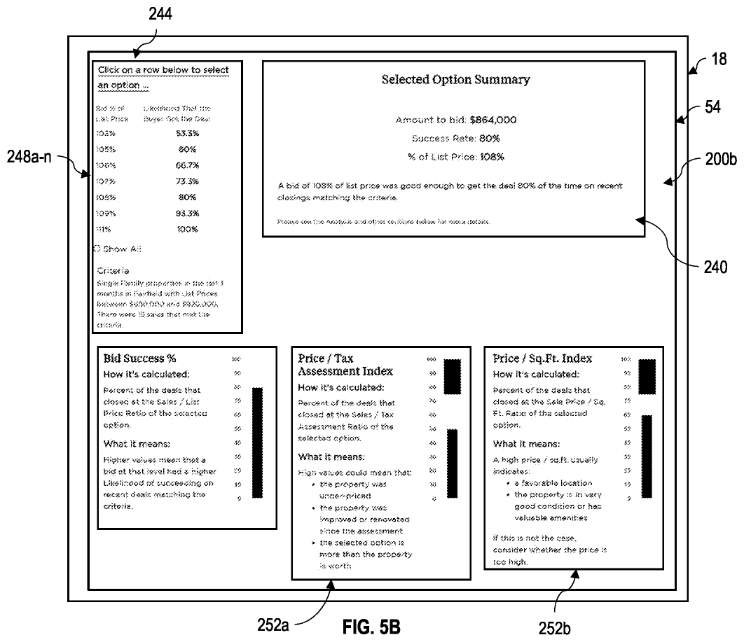

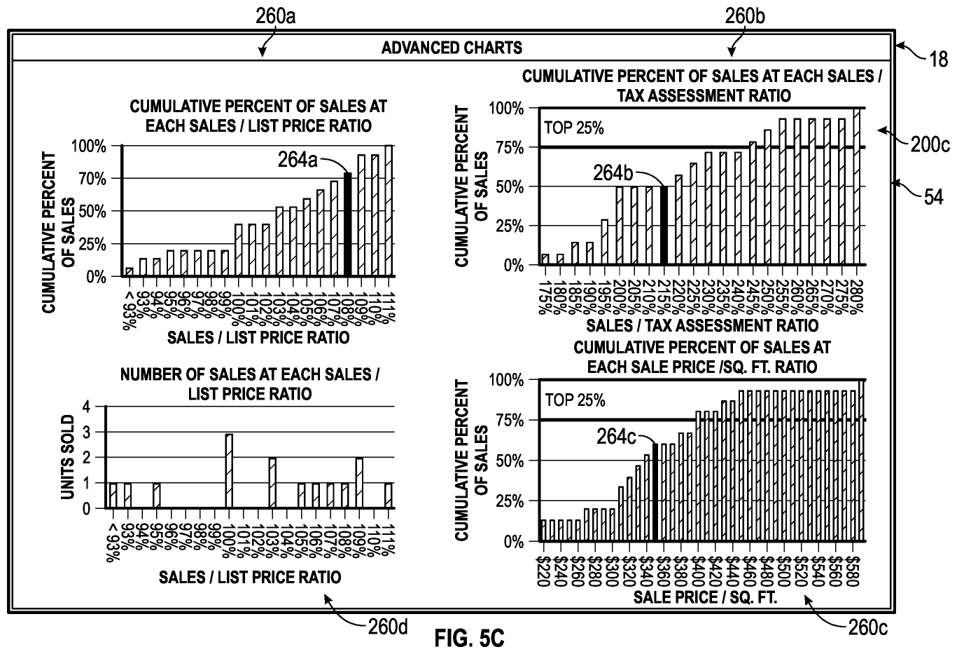

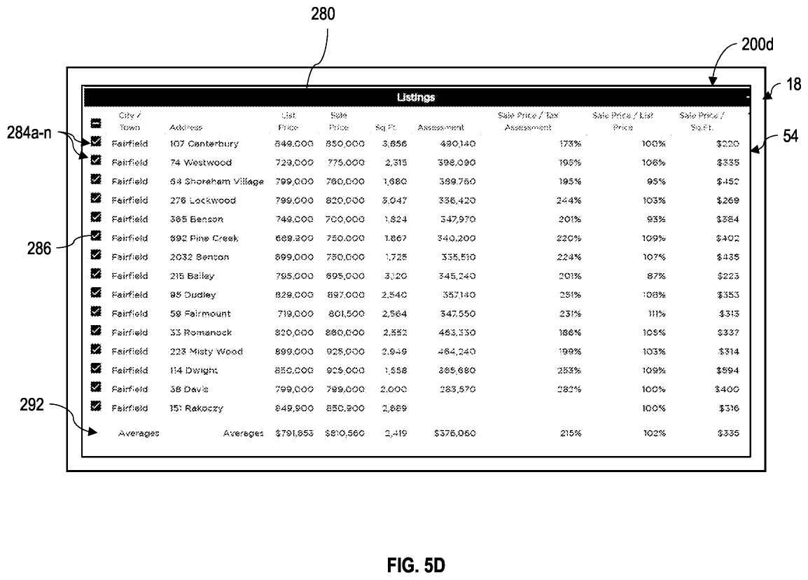

In one embodiment, transmitting, to the user, an interactive interface (step 166) comprises transmitting an assessment index for each frequency distribution. For example, step 166 may include transmitting a price per tax index based upon the price per tax frequency distribution and a price per property size index based upon the price per property size frequency distribution as shown in FIGS. 5A-B.

In one embodiment, transmitting, to the user, an interactive interface (step 166) further comprises indicating on the assessment index, the subject property within each frequency distribution as shown in FIGS. 5A-B.

In one embodiment, upon feedback from the user, return to step 162 (step 170) comprises, receiving a user feedback from the user device via the network 26, the user feedback generated by the user interacting with the interactive interface on the user device 18. Each user feedback may include one or more change to the comparables criteria. When a change to the comparables criteria is detected, the apparatus 22 may restart the bidding assessment process 150 at step 162, that is, the apparatus 22 may then compute bidding options based on the newly received comparables criteria.

Referring now to FIG. 5A, shown therein is a diagram of an exemplary embodiment of an interactive interface 200a on the output device 54 of a user device 18 constructed in accordance with the present disclosure.

The interactive interface 200a generally comprises inputs for one or more property criteria, including, for example, a property location input 204, a property list price input 208, a property size input 212, and a property tax input 216. It should be understood that the number of inputs for the one or more property criteria may include greater or lesser inputs.

The interactive interface 200a further comprises inputs for the one or more comparables criteria, including, for example, a minimum list price input 220a, a maximum list price input 220b, a minimum acres input 224a, a maximum acres input 224b, a minimum comp property size input 228a, a maximum comp property size input 228b, a minimum comp bedrooms input 232a, and a maximum comp bedrooms 232b. It should be understood that the number of inputs for the one or more comparables criteria may include greater or lesser inputs.

Referring now to FIG. 5B, shown therein is a diagram of an exemplary embodiment of an interactive interface 200b on the output device 54 of a user device 18 constructed in accordance with the present disclosure. The interactive interface 200b may comprise a summary pane 240, a likelihood threshold input 244 having a plurality of threshold options 248a-n. Selection of a threshold option 248 generates user feedback that is then transmitted from the interactive interface 200b to the apparatus 22.

The interactive interface 200b may further comprise an assessment index pane 252a, illustrating the assessment index for the sales price per tax frequency distribution of currently selected comparable properties, and a property size index pane 252b, illustrating the sales price per property size frequency distribution of currently selected comparable properties.

Referring now to FIG. 5C, shown therein is a diagram of an exemplary embodiment of an interactive interface 200c on the output device 54 of a user device 18 constructed in accordance with the present disclosure. The interactive interface 200c may display one or more distribution graphs 260a-n plotting each property of the comparables properties alongside a subject indicator 264 for the subject property within each frequency distribution graph 260.

As shown in FIG. 5C, exemplary frequency distribution graphs 260 include a sales price per list price ratio distribution 260a having subject indicator 264a, a sales price per tax distribution 260b having subject indicator 264b, a sales price per property size distribution 260c having subject indicator 264c, and a number of sales at each sales price per list price ratio distribution 260d.

Referring now to FIG. 5D, shown therein is a diagram of an exemplary embodiment of an interactive interface 200d on the output device 54 of a user device 18 constructed in accordance with the present disclosure. The interactive interface 200d comprises a comparables table 280 having a plurality of rows 284a-n, each row 284 associated with a particular comparable property and displaying one or more criteria of the particular comparable property. Each row may include an active toggle 286 indicative of whether a particular comparable associated with the row 284 should be considered in the frequency distributions (detailed above) and/or a summary (detailed below).

Each of the one or more criteria may be displayed in a column 288a-n of the comparables table 280 and may include one or more of a comparable location, a comparable address, a comparable list price, a comparable sale price, a comparable property size, a comparable assessment, a comparable sale price per tax value, a comparable sales price per list price value, and a comparable sale price per property size value, and/or the like.

In some embodiments, the comparables table 280 further includes a summary row 292 providing a summary of each column 288 based on whether the active toggle 286 indicates to include the associated row in the summary row 292. For example, if a particular comparable property is associated with a row 284 and an active toggle 286, and the active toggle 286 is selected by the user to indicate that the particular comparable property should not be considered, then the interactive interface 200d may transmit the user selection to the apparatus 22 as user feedback, and receive, from the apparatus 22, an updated interactive interface 200d showing that the active toggle 286 associated with the particular comparable property is de-selected and showing an updated summary row 292 calculated without the particular comparable property considered.

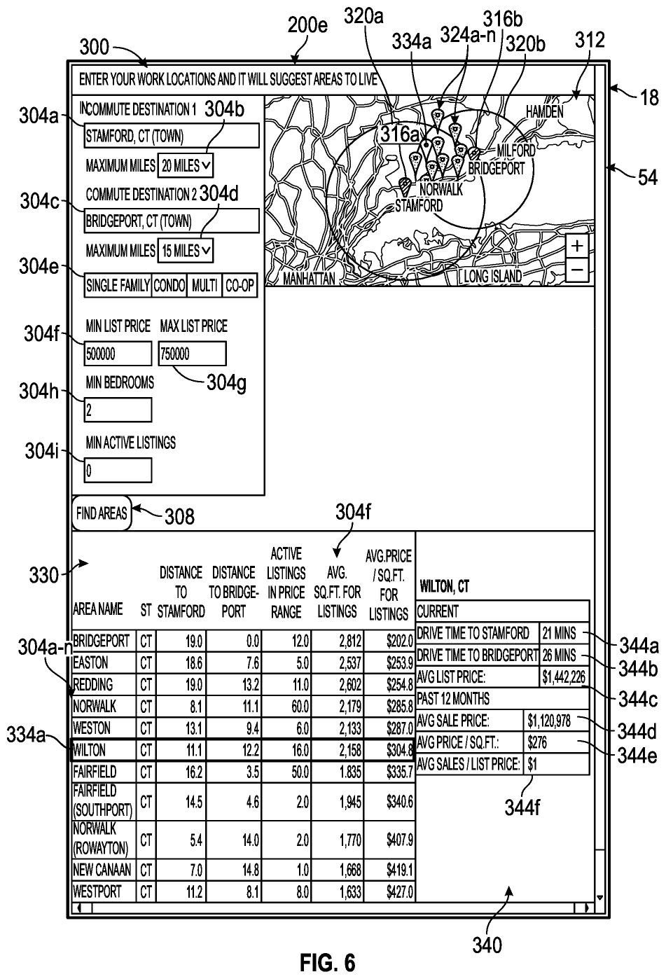

Referring now to FIG. 6, shown therein is a diagram of an exemplary embodiment of an interactive interface 200e on the output device 54 of a user device 18 constructed in accordance with the present disclosure. The interactive interface 200e of FIG. 6 displays a commuting tool 300. The commuting tool 300 may include a plurality of commuting inputs 304a-n, each commuting input 304 indicative of parameters and/or thresholds defined by the user. For example, commuting inputs may include at least a first destination input 304a, a first distance input 304b, a second destination input 304c, and a second distance input 304d.

In one embodiment, one of more of the first destination input 304a and the second destination input 304c may correspond to one or more of a town, city, neighborhood, a school district, an address, an unincorporated community, a district, a city district, a community, and/or the like. While only two destination inputs 304a, 304c are shown, it is understood that more than two destination inputs may be presented to the user via the interactive interface 200e. In some embodiments, the interactive interface 200e may include a commuting input 304 that allows the user to indicate that an additional destination input is desired and, upon selection, presents the user with a third destination input and a third distance input.

In one embodiment, the first distance input 304b and the second distance input 304d may be dropdown menus offering a plurality of predetermined distances, i.e., distances from a location entered in the first destination input 304a and the second destination input 304c, respectively. Alternatively, the first distance input 304b and the second distance input 304d may allow for free text entry, e.g., the user may type a distance value into one or more of the first distance input 304b and the second distance input 304d. The first distance input 304b and the second distance input 304d are shown as distances in units of miles, however, other units may be used to measure distance. Additionally, other distance inputs may be used, for example, one or more of the first distance input 304b and the second distance input 304d may be a time duration, that is, a length of time it takes to get from a community to the destination input, e.g., a driving/walking/public transit/biking/ride-share/scooter duration, for example.

In one embodiment, the commuting inputs 304 further include, for example, a property type 304e, a minimum list price 304f, a maximum list price 3044g, a minimum bedrooms 304h, and/or a minimum active listings 304i.

In some embodiments, upon entering information into one or more of the commuting inputs 304, the interactive interface 200e may update automatically, e.g., based on one or more communication with the apparatus 22. In other embodiments, the interactive interface 200e may transmit a value entered into each of the one or more commuting inputs 304 to the apparatus 22 when a request input 308 is selected.

In one embodiment, upon processing the value from each commuting input 304, the apparatus 22 may transmit suggested communities to the interactive interface 200e. The suggested communities may include one or more community that meets the parameters and/or thresholds defined by the user in each of the commuting input 304a-n. In some embodiments, the suggested communities meet all parameters and/or thresholds defined by the user; however, in other embodiments, the suggested communities may meet a majority of the parameters and/or thresholds defined by the user. In still other embodiments, the suggested communities meet at least one of the parameters and/or thresholds defined by the user.

For example, in one embodiment, the apparatus 22 may transmit the suggested communities that are within both the first distance of the first destination and the second distance of the second destination. This is advantageous, for example, if two individuals wanted to purchase a property together, the first destination may be a work location for the first individual and the second destination may be a work location for the second individual, while the first distance may be a distance that the first individual is willing to drive and the second distance may be a distance that the second individual is willing to drive. In this way, the apparatus 22 may select communities of properties that both the first individual and the second individual may find suitable based upon at least daily driving time to a work location, for example. While a work location is used in the above example, it is understood that any location may be used.

In one embodiment, the apparatus 22 may transmit a map interface 312 indicating a first destination pin 316a, a first distance indicator 320a, a second destination pin 316b, a second distance indicator 320b, and one or more suggested community pin 324a-n. The first destination pin 316a may correspond to a location on the map interface 312 corresponding to a value entered in first destination input 304a. The first distance indicator 320a may correspond to a location on the map interface 312 corresponding to a value entered in the first distance input 304b. The second destination pin 316b may correspond to a location on the map interface 312 corresponding to a value entered in second destination input 304c. The second distance indicator 320b may correspond to a location on the map interface 312 corresponding to a value entered in the second distance input 304d. The one or more suggested community pin 324a-n may correspond to a location on the map interface 312 corresponding to each of the suggested communities.

In one embodiment, the interactive interface 200e may further include a suggested communities table 330 having a row 334a-n corresponding to each suggested community and a column 338 corresponding to a particular aspect of the suggested communities.

In one embodiment, selection of a particular one of the one or more suggested community pin 324a-n, e.g., suggested community pin 324a, may cause a row 334a-n, e.g., row 334a, to highlight, indicating that the selected suggested community pin 324a and the row 334a correspond to the same one of the suggested communities, i.e., the selected community. Likewise, selection of a particular one of the one or more row 334a-n, e.g., the row 334a, may cause the suggested community pin 324a-n, e.g., the suggested community pin 324a, to highlight.

In one embodiment, upon selecting a selected community, the interactive interface 200e may further display a selected community pane 340 displaying one or more additional aspect 344a-n of the selected community. Each aspect 344a-n may include information relative to the values of the commuting inputs 304, such as a drive time to the first destination aspect 344a, a drive time to the second destination aspect 344b, and an average listing price aspect 344c. Additionally, each aspect 344a-n may include information regarding prior sales within the selected community for a predetermined period of time, e.g., shown in FIG. 6 as 12 months. Aspects 344 of the prior sales information may include an average sale price aspect 344d, an average sale price per property size aspect 344e, and/or an average sale price per listing price aspect 344f, for example. It is understood that a fewer or greater number of aspects 344 may be included in the selected community pane 340.

From the above description, it is clear that the inventive concept(s) disclosed herein are well adapted to carry out the objects and to attain the advantages mentioned herein, as well as those inherent in the inventive concept(s) disclosed herein. While the embodiments of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

What is claimed is:

1. A system, comprising:
a processor;
a communication device; and
a memory comprising a non-transitory computer-readable medium storing processor-executable instructions that when executed by the processor, causes the processor to:
receive a plurality of property criteria for a subject property;
receive a plurality of comparables criteria;
calculate one or more suggested bid amount based at least in part on the plurality of property criteria, the plurality of comparables criteria, and a success threshold provided by a user; and
transmit an interactive interface to a user device, the interactive interface displaying the one or more suggested bid amount and operable to transmit a user feedback.

2. The system of claim 1, wherein the one or more suggested bid amount is one or more second bid, and wherein the memory further stores processor-executable instructions that when executed by the processor, further causes the processor to:
in response to the user feedback, alter one or more of the plurality of property criteria, the plurality of comparables criteria, and the success threshold provided by the user into an altered plurality of property criteria, an altered plurality of comparables criteria, and an altered success threshold;
calculate one or more second suggested bid amount based at least in part on the altered plurality of property criteria, the altered plurality of comparables criteria, and the altered success threshold; and
transmit, to the interactive interface shown on the user device, the one or more second suggested bid.

3. The system of claim 1, wherein the plurality of comparables criteria includes two or more of a minimum list price, a maximum list price, a minimum acres value, a maximum acres value, a minimum comp property size, a maximum comp property size, a minimum comp bedroom count, and a maximum comp bedroom count.

4. The system of claim 1, wherein the plurality of property criteria for the subject property includes two or more of a property type, a property location, a property list price, a property size, and a property tax value.

5. The system of claim 4, wherein the property location is one or more of a country, a state, a county, a town, a Zip code, a Post Office, a school district, a borough, a development, a subdivision, a neighborhood, a region, a city, a village, a hamlet, a Census Designated Place, a Metropolitan Statistical Area, an address, a district, and a community.

6. The system of claim 1, wherein the interactive interface is a first interactive interface, and wherein the memory further stores processor-executable instructions that when executed by the processor, further causes the processor to:
transmit a second interactive interface to a user device, the second interactive interface displaying one or more frequency distribution graph having a subject indicator associated with the subject property and plotting the plurality of comparables criteria.

7. The system of claim 6, wherein the one or more frequency distribution graph includes one or more of a sales price per list price ratio distribution, a sales price per tax distribution, a sales price per property size distribution, and a number of sales at each sales price per list price ratio distribution.

8. The system of claim 1, wherein the interactive interface is a first interactive interface, and wherein the memory further stores processor-executable instructions that when executed by the processor, further causes the processor to:
transmit a second interactive interface to a user device, the second interactive interface displaying a comparables table having a plurality of rows associated with a particular comparable property and displaying one or more criteria of the particular comparable property.

9. A system, comprising:
a processor;
a communication device; and
a memory comprising a non-transitory computer-readable medium storing processor-executable instructions that when executed by the processor, causes the processor to:
cause an interactive interface on a user device to display a commuting tool;
receive, from the user, one or more commuting input indicative of commuting parameters; and
display a map interface on the user device, the map interface having one or more distance indicator and a map based on the one or more commuting input and one or more location pin.

10. The system of claim 9, wherein the one or more commuting parameters include one or more of a first destination value, a first distance value, a second destination value, a second distance value, a property type, a minimum list price, a maximum list price, a minimum bedroom count, and a maximum bedroom count.

11. The system of claim 10, wherein the one or more distance indicator is a first distance indicator based on the first distance value centered at the first destination value and a second distance indicator based on the second distance value centered at the second destination value.

12. The system of claim 9, wherein the map interface further includes the one or more location pin being based on one or more suggested community meeting the commuting parameters.

13. The system of claim 9, wherein the memory further stores processor-executable instructions that when executed by the processor, further causes the processor to:
display, on the user device, a suggested communities table having one or more suggested community row, each suggested community row having a community name, community location, a first distance to the first destination value, a second distance to the second destination value, an average listing size, and an average listing price per size.
